(19) United States
(12) Patent Application Publication
(10) Pub. No.: US 2014/0118244 A1
(43) Pub. Date: May 1, 2014

(54) CONTROL OF A DEVICE BY MOVEMENT PATH OF A HAND

(71) Applicant: POINTGRAB LTD., Hod Hasharon (IL)

(72) Inventors: Amir KAPLAN, Hod-HaSharon (IL); Yonatan HYATT, Tel-Aviv (IL); Haim PERSKI, Hod-HaSharon (IL)

(73) Assignee: POINTGRAB LTD., Hod Hasharon (IL)

(21) Appl. No.: 14/061,781

(22) Filed: Oct. 24, 2013

Related U.S. Application Data
(60) Provisional application No. 61/718,542, filed on Oct. 25, 2012.

(51) Int. Cl. G06F 3/01

(52) U.S. Cl. CPC G06F 3/017
USPC 345/156

(57) ABSTRACT

In the invention two consecutive movement paths are detected and displayed content may be manipulated based on the detection of the first movement path of the hand but once a first movement and a second movement path are detected manipulation of the displayed content by the second movement is prevented. Thus, detection of a pair of movement paths prevents unintentional activation of a device.

### PRIOR APPLICATION DATA

The present application claims benefit from U.S. Provisional application No. 61/718,542, incorporated by reference herein in its entirety.

### FIELD OF THE INVENTION

The present invention relates to the field of gesture based control of electronic devices. Specifically, the invention relates to computer vision based hand gesture control.

### BACKGROUND OF THE INVENTION

The need for more convenient, intuitive and portable input devices increases, as computers and other electronic devices become more prevalent in our everyday life. A pointing device is one type of input device that is commonly used for interaction with computers and other electronic devices that are associated with electronic displays. Known pointing devices and machine controlling mechanisms include an electronic mouse, a trackball, a pointing stick and touchpad, a touch screen and others. Known pointing devices are used to control a location and/or movement of a cursor displayed on the associated electronic display. Pointing devices may also convey commands, e.g. location specific commands, by activating switches on the pointing device.

In some instances there is a need to control electronic devices from a distance, in which case the user cannot touch the device. Some examples of these instances include watching TV, watching video on a PC, etc. One solution used in these cases is a remote control device.

Recently, human gesturing, such as hand gesturing, has been suggested as a user interface input tool, which can be used even at a distance from the controlled device. Typically, a hand posture or gesture is detected by a camera and is translated into a specific command.

Gestures, such as a sweep of a finger (“swipe”) on a touchpad, are used to control touch sensitive devices. For example, a swipe of a finger on a touch pad display of a cell phone may cause an application to start and a swipe of a finger on a PC touch screen may cause displayed content to be moved or replaced.

“Swipe” is an intuitive gesture that has become widely used in the control of electronic devices.

Using a “swipe” gesture during touchless gesture control of devices may cause difficulties due to the blur caused when imaging a fast moving object and due to the difficulty in separating intentional swipe motions from accidental or unintentional hand movements. Identifying each sweeping motion of the hand as a swipe gesture may cause an intolerably high number of false identifications.

### SUMMARY OF THE INVENTION

Embodiments of the invention provide a system and method for accurately and smoothly controlling a device using swipe and other gestures.

According to embodiments of the invention gestures fulfilling specific criteria are counted as swipe gestures and may generate user commands and gestures (possibly the same type of gestures) not fulfilling these criteria are not counted as swipe gestures and therefor do not generate user commands. Thus a user can freely move his hands while intending to gesture and when not intending to gesture and the system will be able to determine, based on the criteria, when a swipe gesture was intended and when not, without having to burden the user with inconvenient movements of the hand.

In one embodiment of the invention a method for computer vision based control of a device includes tracking movement of a user's hand through a sequence of images; detecting a pair of movement paths, the pair of movement paths comprising first and second movement paths of the hand, the movement paths of the hand having an interval between them; generating a first user command to manipulate displayed content based on the detection of the first movement path of the hand; and preventing a second user command to manipulate displayed content based on detection of the pair of movement paths of the hand.

In another embodiment a method for computer vision based control of a device may include the steps of applying shape detection algorithms on a sequence of images to detect a shape of a hand in at least one image from a sequence of images; tracking movement of the detected hand shape through the sequence of images; detecting a first movement path of the hand shape and manipulating displayed content based on the detection of the first movement path of the hand shape; and detecting a second movement path of the hand shape and preventing manipulation of displayed content based on the detection of the second movement path of the hand.

The interval between the first and second movement paths is typically below a predetermined value.

Manipulation of displayed content may include moving the content.

According to one embodiment the second movement path is in in a reverse direction to a direction of the first movement path.

According to one embodiment the first movement path is an arc shaped path and the second movement path is a non-arc shaped path (e.g., a linear path).

According to one embodiment the first movement path is a negative arc and the second path movement is a positive arc.

According to one embodiment the first movement path is located higher in an image frame than the location of the second movement path in an image frame.

According to one embodiment the method further includes determining a speed of movement of the user's hand and the first movement path is of a speed that is lower or higher than the second movement path.

According to some embodiments the method includes detecting a shape of the user's hand prior to generating a first user command and generating the first user command only if a shape of a hand is detected.

In a further embodiment of the invention there is provided a system for computer vision based control of a device. The system may include a device having a display and a processor in communication with the device. The processor may be configured to detect first and second movement paths of a hand within a sequence of images, the movement paths of the hand having an interval between them; generate a first user command to manipulate content on the display based on the detection of the first movement path of the hand; and prevent a second user command to manipulate content on the display based on detection of the second movement path of the hand.

The same or additional processor may further be configured to apply a shape detection algorithm on the sequence of images to detect a shape of a hand and to enable manipulation of content on the display based on the detection of the first movement path of the hand and based on the detection of the shape of the hand.

The device may be, for example, any of a TV, DVD player, PC (Personal Computer), mobile phone, camera, STB (Set Top Box) and streamer.

### BRIEF DESCRIPTION OF THE FIGURES

The invention will now be described in relation to certain examples and embodiments with reference to the following illustrative figures so that it may be more fully understood. In the drawings:

FIG. 1 schematically illustrates a method for computer vision based control of a device according to embodiments of the invention;

FIGS. 2A-C schematically illustrate embodiments of the invention;

FIGS. 3A-B schematically illustrate additional embodiments of the invention;

FIGS. 4A-B schematically illustrate other embodiments of the invention; and

FIG. 5 schematically illustrates a system according to an embodiment of the invention.

### DETAILED DESCRIPTION OF THE INVENTION

A system for user-device interaction operable according to embodiments of the invention typically includes a device having a display and an image sensor which is in communication with the device and with a processor. The image sensor obtains image data and sends it to the processor to perform image analysis to detect and track a user's hand or other object from the image data and to detect postures and gestures of the user's hand (or other object) to control the device, typically to control displayed content.

According to embodiments of the invention detection of a particular hand posture or gesture causes the system to interpret hand gestures as a command to manipulate displayed content (e.g., move or change a display).

In the following description, various aspects of the present invention will be described. For purposes of explanation, specific configurations and details are set forth in order to provide a thorough understanding of the present invention. However, it will also be apparent to one skilled in the art that the present invention may be practiced without the specific details presented herein. Furthermore, well known features may be omitted or simplified in order not to obscure the present invention.

Unless specifically stated otherwise, as apparent from the following discussions, it is appreciated that throughout the specification discussions utilizing terms such as “processing,” “computing,” “calculating,” “determining,” or the like, refer to the action and/or processes of a computer or computing system, or similar electronic computing device, that manipulates and/or transforms data represented as physical, such as electronic, quantities within the computing system's registers and/or memories into other data similarly represented as physical quantities within the computing system's memories, registers or other such information storage, transmission or display devices.

Methods according to embodiments of the invention may be implemented in a user-device interaction system which includes a device to be operated and controlled by user commands and an image sensor. Image data of a field view (FOV) captured by the image sensor is sent to the processor for analysis. According to one embodiment a user's hand, within the field of view, is detected and tracked and a posture or gesture or movement of the hand may be identified by the processor, based on the image analysis.

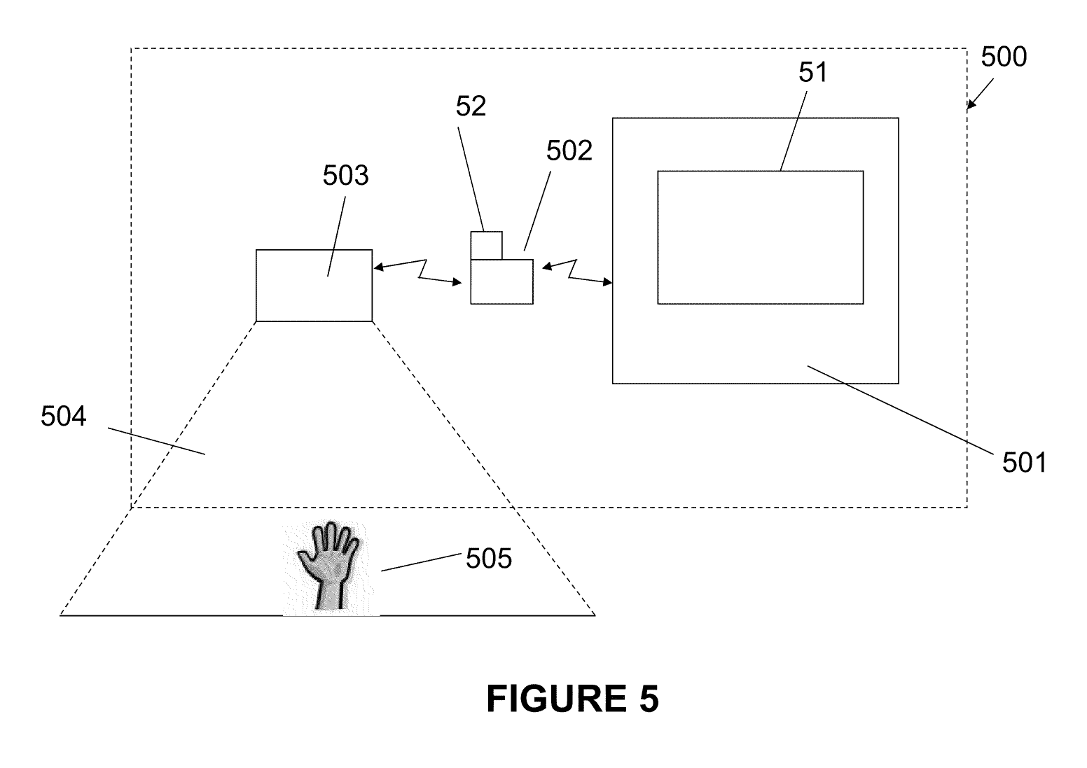

An exemplary system, according to one embodiment of the invention, is described in FIG. 5, below. However, other systems may carry out embodiments of the present invention.

According to an embodiment of the invention a user may move his hand (or other body part or object) in a swipe (or other) gesture or movement to generate a user command such as to slide sideways content displayed on a device screen. During the swipe gesture the user's hand moves in a typical motion pattern (e.g. in a side to side motion). The user may then need to move his hand again (e.g., to bring his hand back to a starting position for another swipe motion) but the user does not intend to gesture during this second movement of his hand. However, since side to side hand motions are used both for “swiping” and for bringing the hand back to its initial position, both motions may be detected as swipe gestures, leading to inaccurate operation of the system.

Thus, the invention provides a way for differentiating between intentional and unintentional gestures, according to one embodiment, by following the user's hand's movement path.

A movement path of a hand typically refers to the trajectory of the user's hand on a 2 dimensional plane within the FOV of a camera or image sensor associated with the system.

According to one embodiment two consecutive movement paths or two movement paths having an interval (e.g., a time interval that is below a predetermined value, e.g., a few seconds) between them are detected and displayed content may be manipulated based on the detection of the first movement path of the hand but once a first movement and a second movement path are detected manipulation of the displayed content by the second movement is prevented. Thus, according to one embodiment it is the detection of a pair of movement paths that prevents unintentional activation of a device.

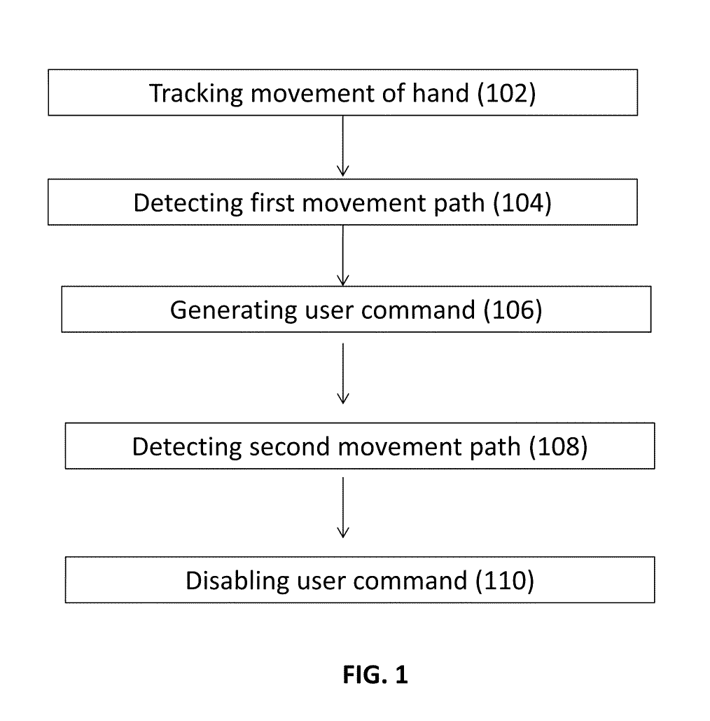

Reference is now made to FIG. 1, which schematically illustrates an example of a method for computer vision based control of a device. According to one embodiment the method includes tracking movement of a user's hand through a sequence of images (102); detecting a first movement path of the hand (104); generating a user command based on the detection of the first movement path of the hand (106); detecting a second movement path of the hand (108); and disabling or preventing a second user command based on detection of the first and second movement path of the hand (110).

If, for example, a swipe gesture is defined as being a left to right movement path then a left to right movement of a user's hand will generate a command (such as to move displayed content or to run an application etc.) whereas a right to left movement path, when detected together with the left to right movement path (e.g., having a small time interval in between the two movement paths), will not enable such a user command. This way, a user may swipe and immediately move his hand back to swipe again without having the displayed content (for example) move back and forth on the display but only move according to the first (and intended) hand movement.

The user command may include changing displayed content on a display, for example, moving displayed content from one side to another on the display. According to one embodiment, the movement of the content may correspond to the movement path of the hand.

The user's hand may be tracked to detect the movement path by known hand tracking methods such as by using optical flow methods. For example, tracking may include selecting clusters of pixels having similar movement and location characteristics in two, typically consecutive images. A hand shape may be detected (e.g., using shape detection algorithms) and points (pixels) of interest may be selected from within the detected hand shape area, the selection being based, among other parameters, on variance (points having high variance are usually preferred). A group of points having similar movement and location parameters is defined and these points are used for tracking. In cases of very quick motion the images may be blurry and optical flow may be difficult to calculate for all or most pixels. According to one embodiment, a blur may be used to indicate motion and optical flow calculations may be used on the few pixels that were not blurred to obtain motion parameters (such as direction of motion etc.) enabling the system to identify and characterize a movement path even from blurry images.

Machine learning techniques may be used to enhance identification of gestures.

According to some embodiments detecting a first movement path of the hand and/or generating a user command based on the detection of the first movement path of the hand may be dependent on initially detecting a shape of a hand, a pre-determined hand posture or hand gesture or another “initializing” signal. Thus, a method may include detecting a shape of a hand or a pre-determined, specific, shape of the user's hand and/or detecting a pre-determined, specific, movement of the user's hand (possibly while the user's hand is in the pre-determined shape) and only then generating a user command based on the detection of the first movement path of the hand.

A threshold interval between detection of the shape of the hand (or shape of specific posture) and the detection of the movement path of the hand may be predefined (e.g., 3 seconds) and swipe gestures may be identified only if the interval between detection of the shape of the hand and the detection of the movement path of the hand is below a predetermined value (e.g., the predefined threshold).

Using an initializing signal such as detection of a shape of a hand or detection of a specific posture and/or gesture of the hand, prior to enabling a “swipe” gesture may lower the number of false recognitions of swipe gestures.

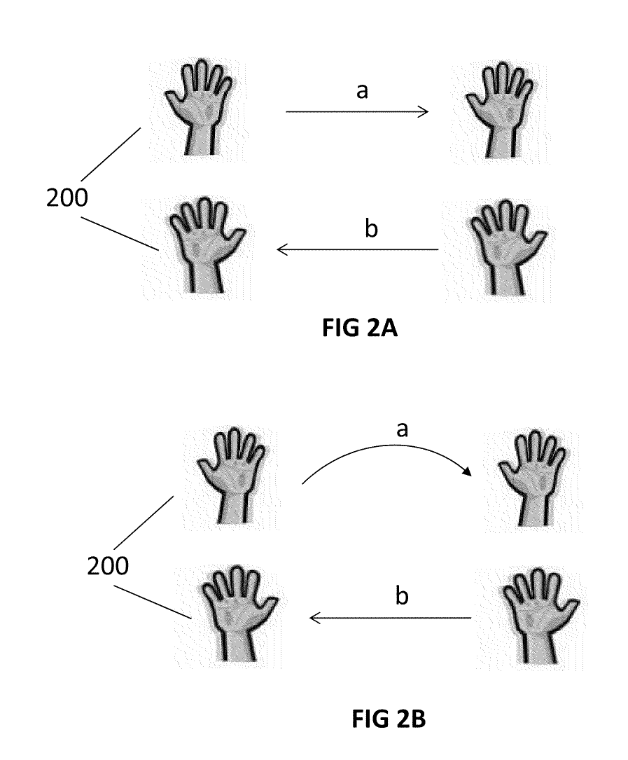

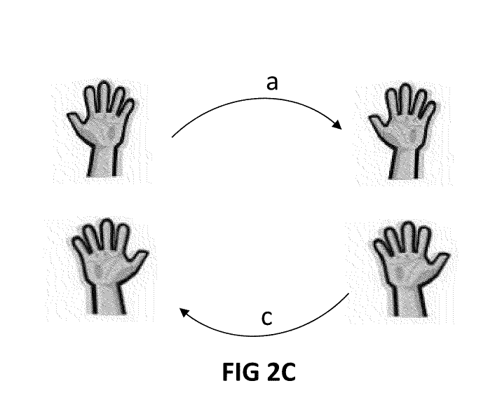

According to one embodiment which is schematically illustrated in FIG. 2A, the second movement path is in in a reverse direction to the first movement path. Thus, when a left to right movement path (a) of the hand is detected, this gesture is interpreted as a swipe gesture and the user may make this gesture in order to manipulate displayed content or for generating other user commands. The same hand movement path but in a reverse path (b) (following the first movement (a) after an interval), for example, if the user wants to return his hand to his initial position 200, will not enable the user command so that content is not manipulated in response to the reverse path (b).

According to some embodiments a movement of a user's hand is tracked through a sequence of images and a user command is generated if an arc shaped movement path of the hand is detected.

According to some embodiments a second movement path of the hand may be detected and if the second movement path is different than the arc shaped movement path of the hand then a user command is disabled.

An arc shaped path may include any curved, nonlinear path. An arc shaped path may include a negative arc (arc which opens downwards) or a positive arc (arc which opens upwards).

According to some embodiments schematically illustrated in FIG. 2B, the first movement path (a) is an arc shaped path and the second movement path (b) is a non-arc shaped path.

Thus, when a curved or arc shaped movement path (a) of the hand is detected, this gesture is interpreted as a swipe gesture and the user may make this gesture in order to manipulate displayed content or for generating other user commands. Typically, when the user returns his hand to his initial position 200 the movement path of the hand is not arc shaped but rather linear. In this embodiment the non-arc shaped path is a linear movement path and is a sign for the system to prevent or not to enable the user command so that content is not manipulated in response to the reverse path (b).

According to another embodiment schematically illustrated in FIG. 2C, the first movement path may be a negative arc, such as movement path (a) and the second path movement is a positive arc, such as movement path (c). Alternatively the first movement path may be a positive arc and the second movement path may be a negative arc. Thus, when a user moves his hand in an arc, e.g., negative arc movement path (a), this gesture is interpreted as a swipe gesture and the user may make this gesture in order to manipulate displayed content or for generating other user commands. An opposite arc, e.g., positive arc movement path (c), is a sign for the system to disable the user command so that content is not manipulated in response to the movement path (c).

According to one embodiment the positive arc movement path (c) does not enable the user command only if it follows (after a predefined interval) a negative arc movement path (a).

According to some embodiments the first movement path is located higher than the second movement path. Thus, if a first movement path ((a) in FIGS. 2A-C) is located at a higher location than a second movement path ((b or c) in FIGS. 2A-C) then the first movement will be identified by the system as a swipe gesture and the second movement will not be identified as a swipe gesture. This embodiment enables a user to gesture at a certain height in order to generate a user command and to then move his hand without intending to gesture at a lower height (which is usually the way a user moves under regular conditions), without generating the user command.

According to one embodiment, in order to avoid interpreting unintentional hand movements as intentional gestures (such as swipe gestures) the speed of the movement of the user's hand is determined and a user command is generated only if the speed of the movement is above a pre-determined value. Similarly other parameters of movement may be determined in addition to or instead of speed. For example, a user command may be generated only in response to movement in a pre-determined direction, having a length above or below a pre-determined value, being continuous and other characteristics whereas if the movement (optionally, a movement following the first movement within a predetermined time interval) does not have the predetermined characteristics the user command is prevented in response to the movement.

According to one embodiment if there are two movements detected at a close time to each other a decision may be made as to which of the two gestures is an intended gesture. For example, a longer and/or slower movement may be determined to be an intended gesture rather than a shorter and/or quicker movement.

Additionally, in a case where many different movement paths are detected at a close time to one another (e.g., above a pre-determined number of paths per specific time period), it may be decided that none of the movements are intended gestures (e.g., a user may be talking while using his hands and is not intending to gesture).

According to some embodiments the size or relative size of a user's hand is determined (e.g., by using shape detection algorithms or by detecting a face and comparing the size of the hand to the size of the face or by other known methods) and a user command may be generated or disabled based on the determined size or relative size of the hand and based on characteristics of the movement detected. For example, if it is determined that a hand is making large movements in relation to the size of the hand then the system may not generate a user command or may disable the user command when detecting these movements.

Thus, according to some embodiments a first movement path of a hand may be interpreted as a swipe gesture and the user may make this gesture in order to manipulate displayed content or for generating other user commands whereas a too large movement of the hand following the first movement may not be interpreted as a swipe gesture and making this gesture will not generate a user command. Further, according to some embodiments, a method may include tracking movement of a user's hand through a sequence of images; detecting a first movement path of the hand; generating a user command based on the detection of the first movement path of the hand; detecting a second movement path of the hand and detecting several different movement paths closely after the second movement path (e.g., within seconds or less); and disabling or preventing a second user command based on detection of the second movement path of the hand.

According to one embodiment the system disables (according to one embodiment—locks) the user command after identifying the first movement path so that movements of the hand performed after the first movement are not recognized as gestures and the user command is not unintentionally activated. According to one embodiment the system may detect an “unlocking” gesture which will enable the user command The unlocking gesture may include a sequence of movements, for example, a sequence of swipe gesture (or any gestures that have a path similar to the first movement path of the hand). Thus, for example, a user may move his hand in a swipe gesture (e.g., from left to right or right to left or in an arc or other gestures) to move displayed content. After a first gesture the system will not identify any other hand movements as swipe gestures until the user again moves his hand in two or more swipe gestures in succession.

Identification of a sequence of movements may enable the system to again identify swipe gestures and to enable user commands or the identification of the sequence may itself generate a user command as would a single swipe gesture.

According to some embodiments a frequency of movements within the sequence is determined and only a sequence of movements having a frequency that is above a pre-determined value is identified as an unlocking gesture.

According to some embodiments the system is locked only if a swipe (or other) gesture is immediately followed by another movement. However, if a user gestures and then keeps his hand still at the end of the gesture the system does not “lock” and the user may continue to gesture again to generate a user command.

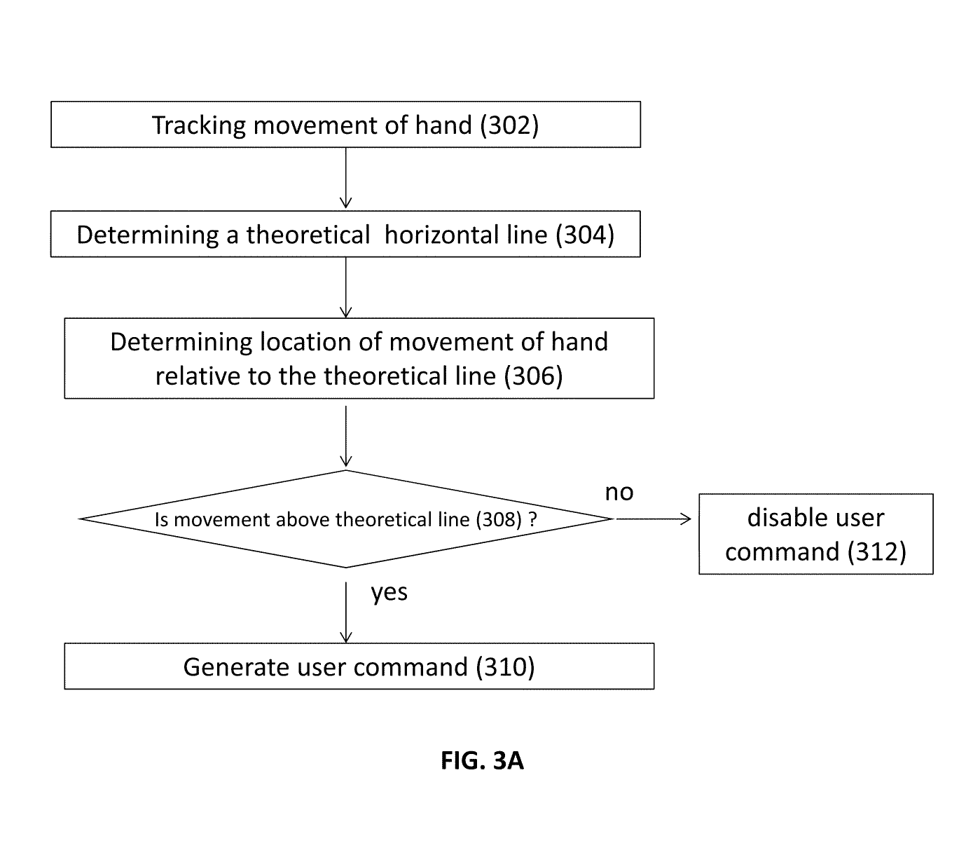

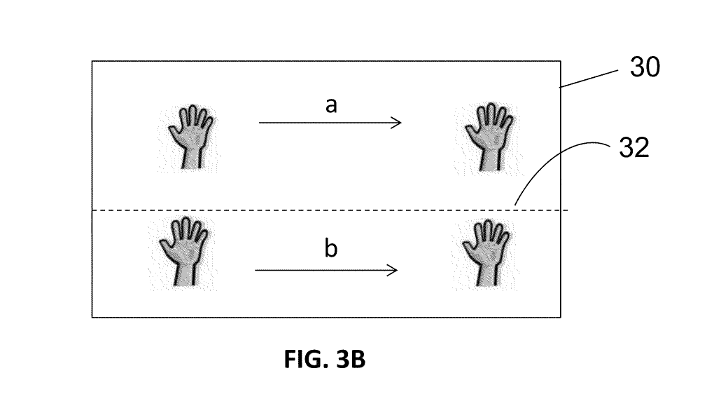

According to one embodiment which is schematically illustrated in FIGS. 3A and 3B, a method for computer vision based control of a device includes tracking movement of a user's hand through a sequence of images (302); determining a theoretical horizontal line running through each image of the sequence of images (304); determining the location of the movement (or of a movement path) of the user's hand relative to the theoretical horizontal line (306); and if the movement of the user's hand is above the theoretical horizontal line (308) then generating a user command based on the movement of the hand (310). According to one embodiment if the movement of the user's hand is not above the theoretical line then the user command is not enabled (312). Thus, the user command may be generated if a first movement of the user's hand (e.g., movement (a) in FIG. 3B) is above the theoretical horizontal line 32 running through each image 30 and not enabled if the movement of the user's hand is below the theoretical horizontal line 32 (e.g., movement (b)).

According to one embodiment the theoretical horizontal line may be determined based on the detection of a face in the image. For example, the line may be determined to be at a specific relative distance from the face. According to other embodiments the line 32 may be a line dividing the image 30 into two substantially equal parts. Other criteria for determining the line 32 may be used.

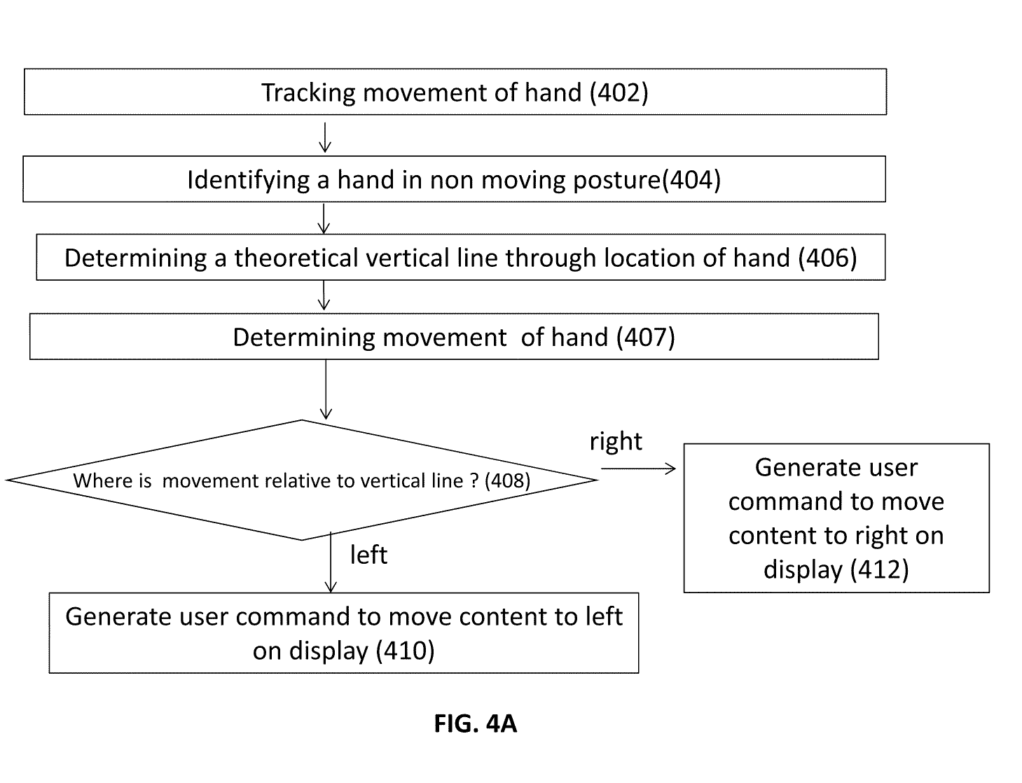

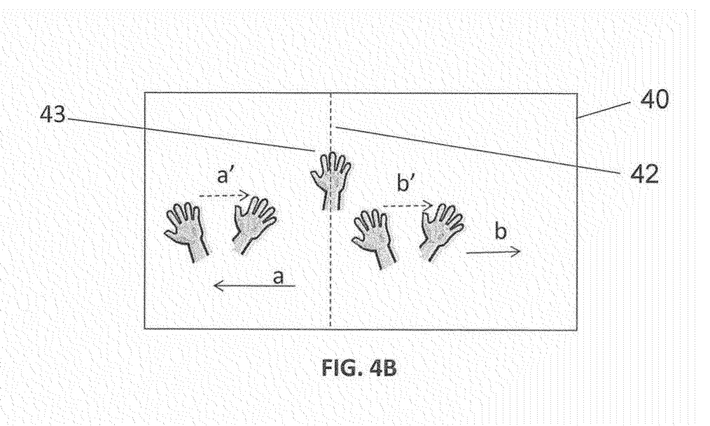

According to other embodiment, schematically illustrated in FIGS. 4A and 4B, a method for computer vision based control of a device includes tracking movement of a user's hand through a sequence of images (402); identifying a shape of a hand in a non-moving posture (404); determining a theoretical vertical line running through the location of the non-moving hand (406); determining movement relative to the theoretical vertical line; and if the movement is in an area left of the theoretical vertical line (408) then generating a user command to move displayed content to the left on a display (410) and if the movement is to the right of the theoretical vertical line (408) then generating a user command to move displayed content to the right on a display (412).

Thus, once a non-moving hand 43 (in FIG. 4B) is identified in an image 40, a theoretical vertical line 42 is drawn through the location of hand 43. The hand may be identified by a specific posture, such as a hand with all fingers open, and/or by the fact that it is not moving. The theoretical line may be drawn through the center of the hand 43 or through any other area at the location of the non-moving hand 43. If movement (a′) is then detected on the left of the line 42 then content will be moved left (a) on the display. If movement (b′) is then detected on the right of the line 42 then content will be moved right (b) on the display.

Thus, according to some embodiments of the invention unintentional gestures are detected by their context. For example, if a second swipe gesture is detected soon after (e.g., within a predetermined time interval or if the interval is below a predetermined value) a first swipe gesture, the second gesture is determined to be unintentional. In another example, if a swipe gesture in a specific direction is detected after a first swipe gesture in the reverse direction, the second gesture is determined to be unintentional. In yet another example, if a swipe gesture is detected at a specific location within an image frame after a first swipe gesture that is located at a higher location on the image frame, the second (lower) gesture is determined to be unintentional. In yet another example, if a swipe gesture performed at a specific speed is detected after a first gesture performed at a different speed (slower or faster) then the second gesture is determined to be unintentional.

A gesture determined to be unintentional does not enable or prevents the generation of a user command.

Methods according to embodiments of the invention are typically performed on a processor within a system which may include a device that may be any electronic device that has or that is connected to an electronic display, e.g., TV, DVD player, PC, mobile phone, camera, STB (Set Top Box) or streamer. The device may be an electronic device available with an integrated standard 2D camera. According to other embodiments a camera is an external accessory to the device. According to some embodiments more than one 2D camera are provided to enable obtaining 3D information. According to some embodiments the system includes a 3D camera.

The processor may be integral to the image sensor or may be a separate unit. Alternatively, the processor may be integrated within the device. According to other embodiments a first processor may be integrated within the image sensor and a second processor may be integrated within the device.

Communication between the image sensor and the processor and/or between the processor and the device may be through a wired or wireless link, such as through IR communication, radio transmission, Bluetooth technology and other suitable communication routes and protocols.

According to one embodiment the image sensor is a forward facing camera. The image sensor may be a standard 2D camera such as a webcam or other standard video capture device, typically installed on PCs or other electronic devices. According to some embodiments, the image sensor can be IR sensitive.

The processor can apply image analysis algorithms, such as motion detection and shape recognition algorithms to identify and further track the user's hand. According to embodiments of the invention shape recognition algorithms may include, for example, an algorithm which calculates Haar-like features in a Viola-Jones object detection framework.

A system operable according to embodiments of the invention is schematically illustrated in FIG. 5. The system 500 may include an image sensor 503, typically associated with a processor 502, memory 52, and a device 503. The image sensor 503 sends the processor 502 image data of field of view (FOV) 504 to be analyzed by processor 502. According to one embodiment a user command is generated by processor 502, based on the image analysis, and is sent to the device 501. According to some embodiments the image processing is performed by a first processor which then sends a signal to a second processor in which a user command is generated based on the signal from the first processor.

Processor 502 may include, for example, one or more processors and may be a central processing unit (CPU), a digital signal processor (DSP), a microprocessor, a controller, a chip, a microchip, an integrated circuit (IC), or any other suitable multi-purpose or specific processor or controller. Memory unit(s) 52 may include, for example, a random access memory (RAM), a dynamic RAM (DRAM), a flash memory, a volatile memory, a non-volatile memory, a cache memory, a buffer, a short term memory unit, a long term memory unit, or other suitable memory units or storage units.

The device 501 may be any electronic device that can accept user commands, e.g., TV, DVD player, PC, mobile phone, camera, etc. According to one embodiment, device 501 is an electronic device available with an integrated standard 2D camera. The device 501 may include a display 51 or a display 51 may be independent, not connected to the device 501.

The processor 502 may be integral to the image sensor 503 or may be a separate unit. Alternatively, the processor 502 may be integrated within the device 501. According to other embodiments a first processor may be integrated within the image sensor and a second processor may be integrated within the device.

The communication between the image sensor 503 and processor 502 and/or between the processor 502 and the device 501 may be through a wired or wireless link, such as through infrared (IR) communication, radio transmission, Bluetooth technology and other suitable communication routes.

According to one embodiment the image sensor 503 is a camera such as a forward facing camera. The image sensor 503 may be a standard 2D camera such as a webcam or other standard video capture device, typically installed on PCs or other electronic devices.

The image sensor 503 may obtain frames at varying frame rates. According to embodiments of the invention the image sensor 503 obtains image data of a user's hand 505 when the hand enters the field of view 504.

According to some embodiments image data may be stored in processor 502, for example in a cache memory. Processor 502 can apply image analysis algorithms, such as motion detection and shape recognition algorithms to identify and further track the user's hand. Processor 502 may perform methods according to embodiments discussed herein by for example executing software or instructions stored in memory 52. When discussed herein, a processor such as processor 502 which may carry out all or part of a method as discussed herein, may be configured to carry out the method by, for example, being associated with or connected to a memory such as memory 52 storing code or software which, when executed by the processor, carry out the method.

Optionally, the system 500 may include an electronic display 51. According to embodiments of the invention, mouse emulation and/or control of a cursor on a display, are based on computer visual identification and tracking of a user's hand, for example, as detailed above.

For example, the system 500 may include a device 501, an imager, such as image sensor 503, to receive a sequence of images of a field of view and a processor, such as processor 502, which is in communication with the image sensor 503 and with the device 501. The processor 502 (or several processors) may detect within an image from the sequence of images an object having a shape of a hand; track at least one first selected feature from within the object; detect a shape of a hand at a suspected location of the object; select at least one second feature to be tracked from within the detected shape of the hand; track the second feature; and control the device 501 based on the tracking of the second feature.

Different embodiments are disclosed herein. Features of certain embodiments may be combined with features of other embodiments; thus certain embodiments may be combinations of features of multiple embodiments.

Embodiments of the invention may include an article such as a computer or processor readable non-transitory storage medium, such as for example a memory, a disk drive, or a USB flash memory encoding, including or storing instructions, e.g., computer-executable instructions, which when executed by a processor or controller, cause the processor or controller to carry out methods disclosed herein.

The foregoing description of the embodiments of the invention has been presented for the purposes of illustration and description. It is not intended to be exhaustive or to limit the invention to the precise form disclosed. It should be appreciated by persons skilled in the art that many modifications, variations, substitutions, changes, and equivalents are possible in light of the above teaching. It is, therefore, to be understood that the appended claims are intended to cover all such modifications and changes as fall within the true spirit of the invention.

1. A method for computer vision based control of a device, the method comprising
tracking movement of a user's hand through a sequence of images;
detecting a pair of movement paths, the pair of movement paths comprising first and second movement paths of the hand, the movement paths of the hand having an interval between them;
generating a first user command to manipulate displayed content based on the detection of the first movement path of the hand; and
preventing a second user command to manipulate displayed content based on detection of the pair of movement paths of the hand.

2. The method of claim 1 wherein the second movement path is in in a reverse direction to a direction of the first movement path.

3. The method of claim 1 wherein the first movement path is an arc shaped path and wherein the second movement path is a non-arc shaped path.

4. The method of claim 3 wherein the non-arc shaped path is a linear path.

5. The method of claim 1 wherein the first movement path comprises a negative arc and the second path movement comprises a positive arc.

6. The method of claim 1 wherein the first movement path is located higher in an image frame than a location of the second movement path in an image frame.

7. The method of claim 1 comprising determining a speed of movement of the user's hand and wherein the first movement path is of a speed that is lower or higher than the second movement path.

8. The method of claim 1 wherein the interval between the first and second movement paths is below a predetermined value.

9. The method of claim 1 wherein manipulating displayed content comprises moving the content.

10. The method of claim 1 comprising detecting a shape of the user's hand prior to generating a first user command and generating the first user command only if a shape of a hand is detected.

11. A method for computer vision based control of a device, the method comprising
applying shape detection algorithms on a sequence of images to detect a shape of a hand in at least one image from a sequence of images;
tracking movement of the detected hand shape through the sequence of images;
detecting a first movement path of the hand shape and manipulating displayed content based on the detection of the first movement path of the hand shape; and
detecting a second movement path of the hand shape and preventing manipulation of displayed content based on the detection of the second movement path of the hand.

12. The method of claim 11 wherein the first and second movement paths have an interval of below a predetermined value between them.

13. The method of claim 11 wherein the second movement path is in in a reverse direction to a direction of the first movement path.

14. The method of claim 11 wherein the first movement path is an arc shaped path and wherein the second movement path is a non-arc shaped path.

15. The method of claim 11 wherein the first movement path comprises a negative arc and the second path movement comprises a positive arc.

16. The method of claim 11 wherein the first movement path is located higher in an image frame than a location of the second movement path in an image frame.

17. The method of claim 11 wherein the first movement path is of a speed that is lower or higher than the second movement path.

18. A system for computer vision based control of a device, the system comprising
a device having a display;
a processor in communication with the device, said processor to:
detect first and second movement paths of a hand within a sequence of images, the movement paths of the hand having an interval between them;
generate a first user command to manipulate content on the display based on the detection of the first movement path of the hand; and
prevent a second user command to manipulate content on the display based on detection of the second movement path of the hand.

19. The system of claim 18 wherein the processor is to apply a shape detection algorithm on the sequence of images to detect a shape of a hand and to enable manipulation of content on the display based on the detection of the first movement path of the hand and based on the detection of the shape of the hand.

20. The system of claim 18 wherein the device is selected from the group consisting of a TV, DVD player, PC (Personal Computer), mobile phone, camera, STB (Set Top Box) and streamer.
